(19) United States
(12) Patent Application Publication
(10) Pub. No.: US 2013/0032128 A1
(43) Pub. Date: Feb. 7, 2013

(54) MOTORCYCLE IGNITION

(71) Applicant: Ed Fralick, Ellsworth, MI (US)

(72) Inventor: Ed Fralick, Ellsworth, MI (US)

(21) Appl. No.: 13/197,943

(22) Filed: Aug. 4, 2011

(51) Int. Cl. F02P 7/07; F02P 7/03

(52) U.S. Cl. 123/595; 123/640

(57) ABSTRACT

A single-fire motorcycle ignition comprising a rotatable shaft having a rotor with two magnets of opposite polarity spaced around the circumference thereof, wherein the shaft and rotor are rotated between latching Hall effect modules, and each module is electrically connected to an ignition coil. Each module is switched to a first position by passage of the first magnet causing the ignition coil to accumulate a charge and a second position by passage of the second magnet, causing the module to fire the ignition coil. The modules are preferably attached to a plate, which can be affixed to the top of a standard breaker base for a points-fired ignition after removal of the condenser and points. A kit to nondestructively convert a traditional points-style ignition to the ignition described herein is also disclosed.

### CROSS-REFERENCE TO RELATED APPLICATIONS

Not Applicable.

### BACKGROUND OF THE INVENTION

1. Field of the Invention

The invention is in the field of ignition devices for motorcycles and a method of converting an existing points-fired ignition to a more reliable electronic ignition.

2. Description of Related Art

Certain traditional points-fired motorcycle ignition systems incorporate points and a condenser. Points generally comprise an electrical breaker switch which is electrically connected to an ignition assembly, wherein the ignition assembly is an induction coil, having a first coil, which is directly electrically connected to the points or breaker switch, and a second coil having more windings than the first coil, which is directly electrically connected to the output of the ignition assembly, and which is positioned so as to be inductively charged by the first coil.

The electrical breaker switch is electrically connected to the first coil of the ignition coil and to a condenser. When the points are closed, the electrical circuit with the first coil is completed, causing the first coil to accumulate a charge. When the points are open, the electrical circuit with the first coil is interrupted, causing the current in the first coil to collapse, thus inducing a charge in the second conductive coil, causing a significant voltage at the output of the ignition coil. The output of the ignition coil is connected to a spark plug, and the increased voltage causes the spark plug to create a spark, which is then used to ignite fuel in the combustion chamber. In a traditional points-fired ignition system the points are reciprocally opened and closed by the rotation of a cam shaft, having a projection thereon which pushes on a lever attached to each of the points individually.

Traditional points-based ignition systems may be single fire or dual fire ignitions. In a single fire ignition for a two-cylinder engine having a dual point breaker, one set of points fires a front engine cylinder, and another set of points fires a rear engine cylinder. Each set of points fires only when desired to ignite the fuel in the chosen engine cylinder (i.e., the points fire one at a time). In a dual fire ignition, a single set of points is used to fire both the front and rear cylinders simultaneously. Sparks are generated by the set of points in each cylinder at the time desired to ignite the fuel in the front cylinder and at the time desired to ignite the fuel in the rear engine cylinder. Each time the points are fired, one spark is considered “wasted,” because it will fire when the engine cylinder is not in a position to have the fuel therein ignited.

Points in a traditional ignition system have a tendency to lose alignment and to arc when a spark bridges the gap between points on the breaker switch. Poor alignment causes a poor electrical connection between points. Poor alignment and dirt, grime or other surface defects on the points may cause burning and pitting, and over time will further reduce the effectiveness of the electrical connection when the points are in contact. Additionally, arcing causes a poor electrical connection, and can cause further damage to the surface of the points. As the electrical connection between the points deteriorates, the electrical current to the first coil is reduced, such that the coil is not effectively charged between cycles, and the output of the ignition system is reduced, leading to poor ignition performance and poor engine performance. Additionally, single fire ignition systems are believed to allow the engine to run cooler and increase the engine's power as compared to dual fire ignition systems.

Conversion kits utilizing latching hall effect switches and a magnetized rotor in place of points have been designed and manufactured by the inventor in the past, however, the use of such systems was limited to use with dual fire systems having a single set of points. Such ignition systems could not be used with a single fire ignition.

The current ignition system is a more effective and reliable alternative to the traditional points-type ignition systems which can be used to convert a points-based single fire ignition or points-based dual fire ignition to a single fire ignition system, and can be installed in vehicles incorporating the older traditional points-fired ignition, whether the original ignition was a single fire or dual fire, without significant modification to the vehicle or to the structures of the ignition.

### BRIEF SUMMARY OF THE INVENTION

The invention comprises a single-fire ignition device, which can be installed in place of a points-fired ignition system, comprising a fixedly mounted front module and a fixedly mounted rear module, a rotatable shaft with its cam end terminating between the front and rear modules, and a rotor with two magnets therein, having opposite polarities, fitted on the cam end of the shaft between the modules, wherein the front and rear modules are latching Hall effect switches capable of firing ignition coils and are activated and de-activated by spinning the magnet-impregnated rotor passing in close proximity to the front and rear modules. The invention further comprises a kit for converting a traditional points-fired ignition system to the ignition device described herein, comprising a conversion plate which fits over an existing breaker base for non-destructive attachment of the front and rear modules, a front module, and a rear module. The invention also comprises a method for such conversion.

### BRIEF DESCRIPTION OF THE SEVERAL VIEWS OF THE DRAWING

FIG. 1 is a top perspective view of the traditional dual point single fire ignition device;

FIG. 2 is top perspective view of a motorcycle ignition device according to the invention, with the outer cover shown;

FIG. 3 is an exploded top perspective view of an embodiment of the motorcycle ignition device according to the invention;

FIG. 4 is top view of an embodiment of the conversion plate used in the motorcycle ignition device; and

FIG. 5 is a top view of an embodiment of the conversion plate used in the motorcycle ignition device with the modules installed.

### DESCRIPTION OF THE PREFERRED EMBODIMENTS OF THE INVENTION

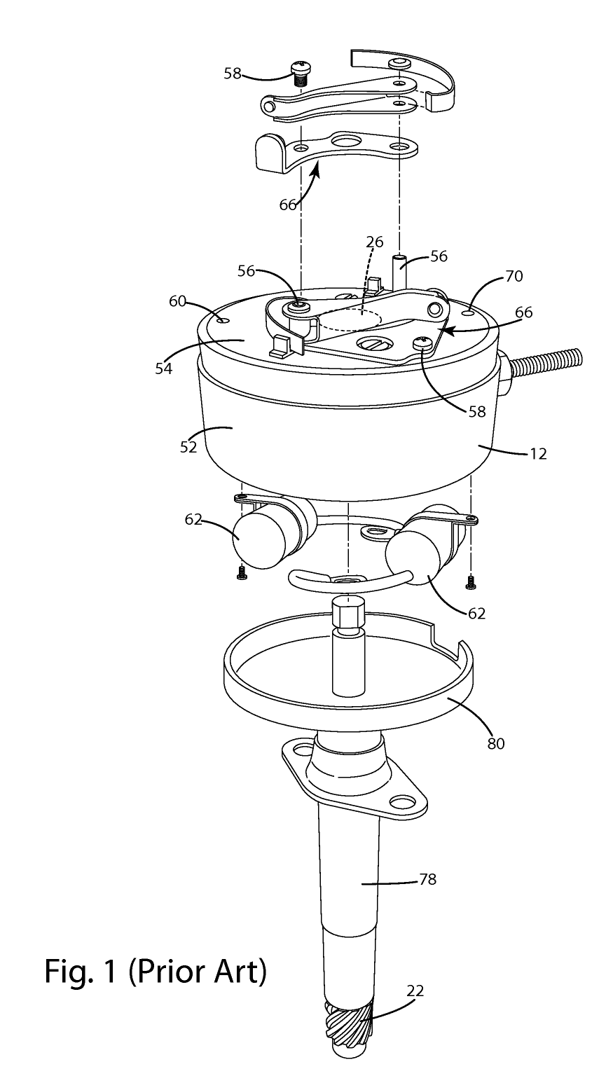

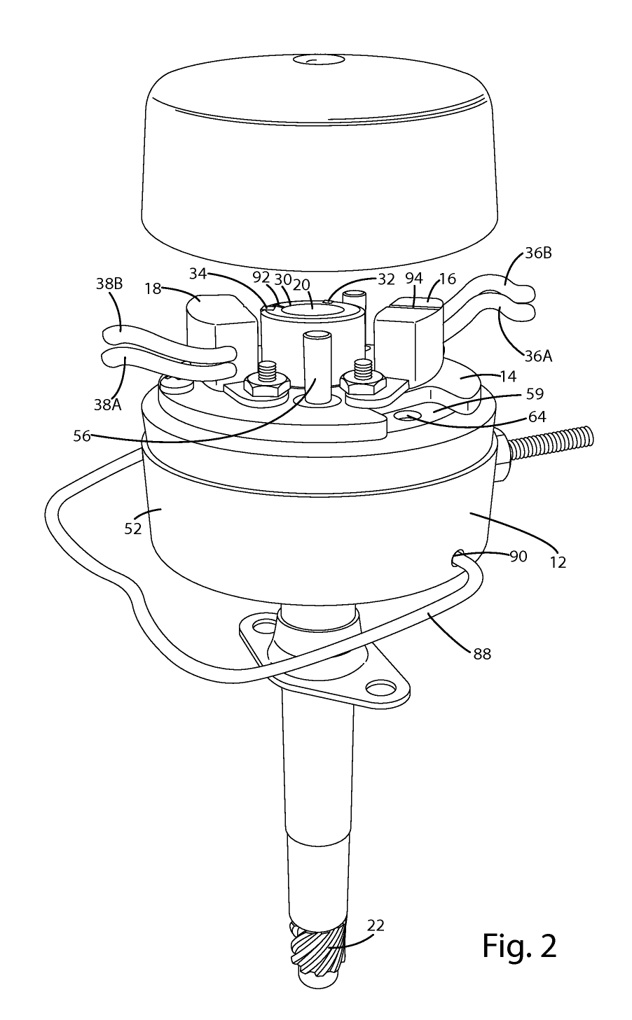

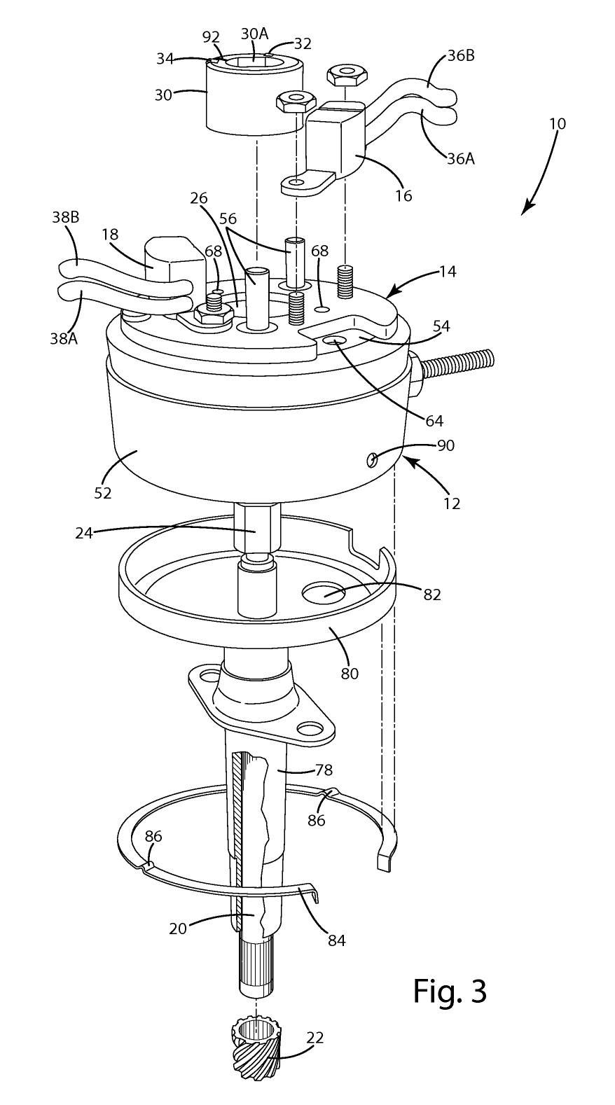

In a preferred embodiment, the single-fire ignition device 10 includes several components from a traditional points-fired ignition, as shown in FIG. 1. The preferred ignition 10 comprises: a breaker base 12, a conversion plate 14 attached to the top of breaker base 12 and having a two modules 16, 18 attached thereto, a rotatable shaft 20 having a first end with a gear 22 and having a second end 24 which is threaded through a central opening 26 in breaker base 12 and a central opening 28 in conversion plate 14 and extending between modules 16, 18, and a rotor 30 which fits over the end of shaft 20 between modules 16, 18 and incorporates at least two magnets 32, 34 therein. (FIGS. 2-3). Modules 16, 18 are electrically wired with wires 36A, 38A to ignition coils which cause spark plugs to fire, igniting fuel in the engine cylinders. Modules 16, 18 replace traditional points, so as to create a more reliable ignition.

Motorcycle ignition device 10 operates generally according to the Hall effect, and more particularly according to the latching Hall effect. Pursuant to the Hall effect, applying a magnetic field in a direction which is generally perpendicular to the electric current in an electrical conductor induces a voltage differential in the electrical conductor. When the perpendicular magnetic field is applied, the moving electrical charges accumulate on one face of the conductor. This creates an asymmetric distribution of charge within the conductor, and the asymmetrical distribution creates an electric field. This electric field opposes the migration of further charge and the electrical potential builds while the electric current is flowing.

Pursuant to the latching Hall effect, a digital latch or switch is provided, wherein the switch is placed into a first state by the application of a magnetic field of a first polarity, and wherein the switch remains in the first state until a sufficiently strong magnetic field of the opposite polarity is applied. When a strong enough magnetic field of the opposite polarity is applied, the switch is placed into a second state, where it will remain until a sufficiently strong magnetic field of the first polarity is again applied to the switch.

Latching Hall effect switches are commercially available in a variety of configurations and which are activated by a variety of operating thresholds, i.e., requiring a different strength of magnetic field to change the state of the switch.

In the operation of the preferred motorcycle ignition device 10, each module 16, 18 functions as a latching Hall effect switch, wherein each switch is placed into a first state by the application of a first magnetic field, and where the switch remains in the first state until a magnetic field having sufficient strength and the opposite polarity is applied. The latching Hall effect switches for use as modules 16, 18 with motorcycle ignition device 10 are preferably for use with a 6V or a 12V power supply, or for a range which incorporates these voltages (as this is the range of the power supply generally encountered in motorcycles), and one that requires a relatively strong magnetic force to be applied in order to avoid inadvertent firing of the ignition coil or interference from other sources of magnetic fields likely to be encountered in use.

Magnetic fields are applied to modules 16, 18 by magnets 32, 34 in rotor 30, and modules 16, 18 are electrically connected to front and rear ignition coils, respectively, via output electrical wires 36A and 38A. When rotor 30 is rotated to a certain first position, first magnet 32 having a first polarity is aligned directly opposite front module 16, applying a magnetic field transverse to module 16. Passage of first magnet 32 causes module 16 to be placed in a first switch orientation, such that a charge is accumulated in the ignition coil. Then, as rotor 30 continues to rotate to a second orientation, second magnet 34, having a polarity opposite to first magnet 32, is aligned directly opposite front module 16, causing reversal of the switch and placement of module 16 in a second orientation, such that the accumulated charge in the ignition coil is released. This release of charge causes the front ignition coil and front spark plug to fire, igniting fuel in the front cylinder.

The same process is repeated when first magnet 32 and second magnet 34 pass by rear module 18, causing the rear ignition coil to accumulate and then release a charge, causing rear spark plug to fire, igniting fuel in the rear cylinder.

The rotation of rotor 30 cyclically turns on and turns off each module 16, 18 as first magnet 32 and second magnet 34, respectively, pass by the relevant module 16, 18 causing each module 16, 18 to fire an ignition coil and thus a spark plug one time for each rotation of rotor 30. The circumferential distance X between magnets 32, 34 on rotor 30 sets the dwell time for each module 16, 18, and determines how much charge will be accumulated in the ignition coil before the ignition coil fires the spark plug. The fixed dwell time (per rotational speed) that is created as a result of the circumferential distance X between magnets 32, 34 provides consistently timed firing of the spark plugs, allowing the engine to run efficiently and allowing ignition coils to be fully energized for each firing.

Additionally, the relative circumferential spacing of front module 16 and rear module 18 controls the timing for firing of the spark plugs for front and rear engine cylinders, which relative timing will remain fixed once modules 16, 18 are fixed in position. For motorcycles having an uneven cylinder firing arrangement, including certain Harley Davidson models, the modules 16, 18 can be located at less than 180 degrees from each other in order to accommodate the desired engine cylinder firing timing, and to maintain the same firing timing that was intended to be carried out by original ignition system, such as a dual point system.

To determine appropriate relative positioning of modules 16, 18 on conversion plate 14, an evaluation of the firing time in the traditional points fired ignition which is to be replaced by motorcycle ignition device 10 can be carried out using an electric distributor machine, such as a Sun Distributor Tester machine, model 504, which measures the timing of the points fired system, and can be used to match the timing of ignition device 10 to the desired timing exhibited by the ignition being replaced. Once such a calculation is made, and the position of modules 16, 18 is determined, this measurement does not need to be carried out again, because the fixed locations of modules 16, 18 ensures that the relative timing will remain consistent.

To construct a preferred motorcycle ignition device 10, a breaker base 12, such as one provided in an existing single-fire dual points motorcycle ignition, may be used as the base for installation of conversion plate 14 and modules 16, 18. (FIGS. 2-3) Alternatively, an entire motorcycle ignition device 10 can be constructed using new parts which have the same dimensions as traditional ignition systems, where appropriate, so that motorcycle ignition device 10 can be used to retrofit existing vehicles without resizing or modification of adjacent structures.

In one preferred embodiment, motorcycle ignition 10 is intended to replace a dual points single-fire breaker used in Harley Davidson motorcycles prior to the modern electric ignition, such as the stock ignition used in a Harley Davidson Panhead from about 1961 to about 1963. In this preferred embodiment, breaker base 12 is generally cylindrical in shape, with a side wall 52 and one end wall 54. (FIGS. 1-3)

End wall 54 has a central opening 26 for passage of shaft 20, two posts 56 extending therefrom, two adjustment screws 58, and two screw holes 60 where a condenser 62 would have been attached in a traditional single fire dual points ignition configuration. End wall 54 also has two holes 64 for the passage of wires 36, 38 leading from modules 16, 18. If breaker base 12 from an existing motorcycle ignition will be used to create the motorcycle ignition device 10 described herein, the motorcycle ignition should first be disconnected from any electrical supply and the condenser 62 and points 66 that are present should be removed, and breaker base 12 removed from the remainder of the ignition. (FIG. 1)

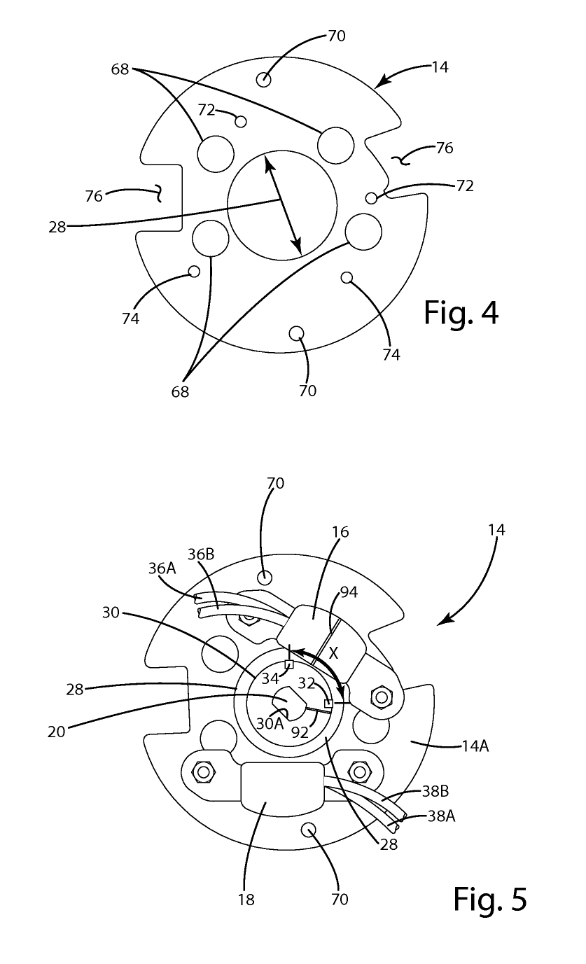

Conversion plate 14, having a shape which is complementary to end wall 54 of breaker base 12, and including a central opening 28 for passage of shaft 20, four holes 68 through which posts 56 and adjustment screws 58 extending from breaker base 12 pass, two screw holes 70 which align with the breaker base 12 condenser screw holes 60, and two screw holes 72 for attachment of front module 16, and two screw holes 74 for attachment of rear module 18. (FIG. 4) Conversion plate 14 also has openings 76 to permit passage of wires 36, 38 through holes 64 in breaker base 12.

Use of conversion plate 14 is preferred, particularly if kits will be sold to individual owners to modify existing motorcycle ignition systems because the conversion plate 14 can be provided with the necessary holes pre-drilled so that no special tools are required to attach or assemble the motorcycle ignition device 10, and so that the position of modules 16, 18 (and therefore relative ignition timing of the cylinders) will be predetermined, allowing easier amateur installation.

Front module 16 and rear module 18 are fixedly attached to the top side of conversion plate 14A, preferably using screws or other fasteners through screw holes 72 for each front module 16 and screw holes 74 for rear module 18. (FIGS. 4-5) Modules 16, 18 are fastened in a circumferential arrangement around central opening 28 of conversion plate 14. In the preferred embodiment described herein, to accommodate the cylinder arrangement of a Harley Davidson Panhead engine, front and rear modules 16, 18 are placed at about a 163 degree angle from each other, around the central axis of conversion plate 14, and holes are pre-drilled in conversion plate 14 to accommodate such placement. In a preferred embodiment, modules 16, 18 are two position latching Hall effect switches, with negative grounds and two output wires 36A, 36B, 38A, 38B, and are intended for use with from about a 6V to about a 12V power supply.

Conversion plate 14 is installed on breaker base 12 by placing conversion plate 14 against end wall 54 of breaker base 12 with side 14A facing away from breaker base 12 so that the central openings 26, 28 are aligned, and the posts 56 and adjustment screws 58 extend through the four corresponding screw holes 70 on conversion plate 14. (FIG. 3)

Conversion plate 14 is securely affixed to end wall of breaker housing 12, preferably using screws to attach conversion plate 14, such screws through aligned holes 70 in conversion plate 14, and holes 60, used to attach condensers 62 in a traditional motorcycle ignition. Using screws or other removable methods of attaching conversion plate 14 to breaker base 12 permits non-destructive installation of the preferred motorcycle ignition described herein, so that the system can be restored to the original ignition system, if desired. However, more permanent methods of attaching conversion plates, such as welding or modification of end wall 54 itself to accommodate the modules and rotor would also be possible.

Shaft 20, having a length which is sufficiently long to extend from gear 22 up through central openings 26, 28 is installed in a generally standard ignition breaker structure, comprising a gear 22 mechanically attached to one end of shaft 20, with shaft 20 partially enclosed in a generally cylindrical stem case 78 which terminates in a breaker housing 80 that fits into the open end of breaker base 12. Breaker base 12 and conversion plate 14 with modules 16, 18 attached thereto are then installed over shaft 20 and breaker housing 80.

To install breaker base 12 with conversion plate 14 over breaker housing 80, wires 36, 38 are fed through holes 64 on breaker base 12, and through a hole 82 in the bottom of breaker housing 80. Then, side wall 52 of breaker base 12 is aligned with the corresponding top side of breaker housing 80, and breaker base 12 is closed over breaker housing 80. When breaker base 12 is installed on motorcycle ignition device 10, end 24 of shaft 20 extends upwards through central holes 26, 28, and terminates between modules 16, 18.

One wire 36A, the electrical output from module 16, is electrically connected to an ignition coil for the front cylinder, and the electrical input wire 36B may be wired to the key switch or to the other side of ignition coil (where the key is generally wired). Similarly, output wire 38A from rear module 18 is attached to an ignition coil for the rear cylinder, and the input wire 38B from rear module 18 may be wired to the key switch or to the other side of the ignition coil, as done for wires 36A and 36B.

Breaker base 12 is retained in place on ignition device 10 via a retaining feature comprising a partial ring 84 which fits around the outer edge of breaker housing 80, on the bottom side thereof, having indentations 86 therein, and a cover retaining loop 88, having inwardly directed ends which are tension fit around breaker base 12 and into receiving holes 90 in breaker base 12, below breaker housing 80 and into the indentations 86 in ring 84. (FIGS. 2-3)

Rotor 30, comprising a generally cylindrical sleeve with two earth magnets 32, 34 having opposite polarities spaced a defined distance X apart along the circumference of rotor 30, is installed over the end of shaft 24 between modules 16, 18, with rotor 30 fitting tightly around the circumference of shaft 20. (FIGS. 3, 5) Preferably, shaft 20 and the interior surface of rotor 30A do not have a circular cross sectional shape, and more preferably, the cross sectional shape is an oval or an asymmetrical or “egg” shape, so as to prevent rotation of rotor 30 around shaft 20 and, if an asymmetrical shape is used, so that rotor 30 will only fit over shaft 20 in a single orientation.

First and second magnets 32, 34 are preferably sized to fit easily within the thickness or depth of rotor 30 and so that they do not greatly exceed the height of rotor 30. The width of magnets 32, 34 is also preferably such that they do not significantly interrupt the cylindrical curvature of rotor 30. One particularly preferred size for magnets 32, 34 for the single-fire ignition 10 described herein is about 0.10 inch thick, about 0.12 inches wide, and about 0.20 inches tall. The particular measurements of magnets 32, 34 is not critical, though the magnets 32, 34 should fit within rotor 30 and be sufficiently sized to align with modules 16, 18. Magnets 32, 34 are preferably strong magnets for their size, such as rare earth magnets, and are rotated in close proximity to modules 16, 18, such that magnets 32, 34 create a strong magnetic field to reliably and repeatedly activate and deactivate modules 16, 18, with limited interference from other magnetic objects.

The configuration of rotor 30 and magnets 32, 34 on rotor 30 is preferably such that magnets 32, 34 pass less than about 0.060 inches from modules 16, 18 and preferably less than 0.040 inches, and most preferably at about 0.015 inches from modules 16, 18 when rotor 30 is rotated by shaft 20. It is preferable to have at least a minimal air gap, so that rotor 30 does not touch modules 16, 18, as this can cause wear on modules 16, 18 and on rotor 30. In the preferred embodiment described herein, the outer diameter of rotor 30 is about 1 inch, and more preferably from about 1.020 inch to about 1.025 inches, and magnets 32, 34 of the size described above are preferably placed about 0.6 inches to about 0.625 inches apart around the circumference of rotor 30, measured along the interior of one magnet 32 to the interior of the other magnet 34, so as to permit a dwell time between the passage of magnets 32, 34 sufficient for ignition coils to be adequately charged.

Despite the use of various input voltages, such as the use of a 6V battery or a 12V battery in various designs, the preferred embodiment described herein may be used, even with the same rotor 34, having a fixed magnet 32, 34 configuration. Due to the relationship between the dwell time (created by the spacing of magnets 32, 34 around rotor 30) and the charging of ignition coils, the resistance of the ignition coils can be varied to permit the ignition coils to be adequately charged when a certain incoming voltage will be used. For example, an ignition coil resistance of from about 1.2 to about 3 ohms is preferable when a 6V power source is used, and an ignition coil resistance of from about 2.7 to about 4.7 ohms is preferable when a 12V power source is used.

Rotor 30 and front module 16 preferably incorporate timing marks 92, 94 on the top sides thereof. These timing marks 92, 94 are used to initially set the timing of front module 16 to fire the front cylinder of the engine of the motorcycle ignition device 10 at the desired time, when at the compression stroke of the cylinder. Once the timing of front module 16 is set, the fixed location of modules 16, 18 on conversion plate 14 determines the timing of rear module 18 as a function of the timing of first module 16, and means that the timing of the firing will be fixed once it is set.

Determining the proper stroke position for setting timing of the ignition is not unique to the present invention, and the exact method may vary to some degree based on the make and model of the engine. Generally, to set the timing, spark plugs are removed and the front cylinder is brought up on the compression stroke. To find the compression stroke in certain engines, a finger or thumb can be placed over the spark plug hole in the cylinder, and then the engine is turned over slowly until compression is felt. At this point, the plug is removed from a timing inspection hole on the side of the crank case, and the engine's flywheel is brought to the timing mark in the hole, according to the manual for the engine. Once the timing mark is in place in the inspection hole, the timing inspection plug may be reinstalled, and the rotor timing mark 92 is aligned with timing mark 94 on front module 16. Following alignment, spark plugs are reinstalled.

The motorcycle ignition device 10 described herein may also be used to replace a traditional dual-fired ignition. Conversion plate 14 can, of course, be tailored to fit the structures present on the dual-fired ignition breaker 12, and to continue to permit the non-destructive conversion by installation of a front and rear module 16, 18 as described above. Additionally, when converting from a dual-fired ignition to a single-fired ignition 10, several additional performance benefits may be realized, in addition to the increased performance and reliability of the motorcycle ignition 10 over a points-fired ignition. The single-fired ignition 10 allows the engine to run cooler, without the wasted spark, and increases engine power.

The motorcycle ignition device 10 described herein may be packaged and sold as a unit, incorporating all necessary pieces, or, the pieces which vary from the traditional ignition system being converted may be sold as a kit, allowing a user to easily reconfigure an existing motorcycle ignition. Particularly, a kit comprising the conversion plate 14, modules 16, 18, and rotor 30 with impregnated magnets 32, 34 would permit even a non-skilled user to nondestructively convert an existing single-fire dual points ignition or dual-fire single points ignition to the ignition device 10 described herein. As described above, conversion plate 14 having pre-formed holes for attachment of modules 16, 18 ensures that the relative timing of firing for the front and rear cylinders will be fixed and that modules 16, 18 will be in an appropriate position and orientation for magnets 32, 34 in rotor 30 to activate and deactivate modules 16, 18. The fixed distance between magnets 32, 34 as provided in a kit will also ensure that the dwell time is sufficient to adequately charge the recommended ignition coils.

Of course it is understood that the above is a description of preferred embodiments, and that various changes and alterations can be made to the motorcycle ignition device or kit for converting an existing motorcycle ignition without departing from the spirit and broader aspects of the invention.

What is claimed is:

1. A single fire ignition device, comprising:
a rotatable shaft, having a first end and a second end;
a rotor attached to the first end of the shaft, wherein the rotor has a first magnet and a second magnet, the first magnet and second magnet being oriented with opposite polarities;
a front module and a rear module, each having an inner face, wherein said front and rear modules fixedly attached to a base and are positioned radially outward from the rotor with the inner faces directed generally toward the rotor, and wherein the front module is electrically connectable to a front ignition coil and the rear module is electrically connectable to a rear ignition coil; and
wherein the each module comprises as a latching hall effect switch, which is placed into a first state by the first magnet being aligned with the inner face, wherein the module accumulates an electronic charge when the switch is in the first state, and wherein each switch is placed into a second state by the second magnet being aligned with the inner face, wherein the module generates an electrical output when it is in the second state, wherein the electrical output from the module causes the ignition coil to fire if the ignition coil is electrically connected to the module.

2. The ignition device of claim 1, wherein the base is a conversion plate.

3. The ignition device of claim 2, wherein the conversion plate is mechanically attached to a breaker base.

4. The ignition device of claim 3, wherein the conversion plate has openings therein to accommodate structures on top of a traditional breaker base, and wherein the conversion plate is mechanically attached to the traditional breaker base via existing holes in a traditional breaker base.

5. The ignition device of claim 1, wherein the rotor comprises a hollow generally cylindrical body, with an outer side wall incorporating the first and second magnets, an opposed interior side wall, and at least one open end.

6. The ignition device of claim 5, wherein the interior side wall is complementarily shaped to the first end of the shaft, and the rotor is friction fit around the first end of the shaft.

7. The ignition device of claim 6, wherein the cross sectional shape of the first end of the shaft is not round.

8. The ignition device of claim 7, wherein the cross sectional shape of the first end of the shaft is oval.

9. The ignition device of claim 7, wherein the cross sectional shape of the first end of the shaft is asymmetrical.

10. The ignition device of claim 1, further comprising:
a gear attached to the second end of said rotatable shaft, wherein the gear is used to drive rotation of the shaft and the rotor attached thereto.

11. A kit for converting a points-fired ignition to a single-fire ignition device, comprising:
a conversion plate;
a front module and a rear module, said front and rear modules comprising latching hall effect switches, said front module having a first electrical output which is electrically connectable to a first ignition coil and said rear module having a second electrical output which is electrically connectable to a second ignition coil; and
a rotor, having a first magnet and a second magnet, wherein the first magnet and second magnet are oriented with opposite polarities.

12. A kit for converting a points-fired ignition to a single-fire ignition device as described in claim 11, further comprising:
A shaft, having a first end and a second end, wherein the rotor fits snugly over the first end.

13. A kit for converting a points-fired ignition to a single-fire ignition device as described in claim 11, wherein the kit is adapted for use with a points-fired ignition having a gear to drive a rotatable cam shaft, said rotatable cam shaft extending from the gear through a stem case and a breaker and breaker base to terminate adjacent to a points assembly, wherein the second end of the shaft is adapted to mechanically attach to the gear, and the shaft has a sufficient length to extend from the gear through the stem case, breaker, breaker base and conversion plate.

14. The conversion kit of claim 13, wherein the conversion plate has pre-formed openings permitting placement flush with the top of the breaker base.

15. The conversion kit of claim 15, wherein the conversion plate has pre-drilled holes for mechanical attachment of the first and second modules.

16. The conversion kit of claim 15, wherein the kit is intended to convert a points-fired ignition having at least two points-assemblies, wherein there are the same number of modules as points assemblies in the point-fired ignition, and wherein the pre-formed openings and pre-drilled holes are arranged so as to make relative timing between the at least two modules the same as what was provided by the at least two points-assemblies.

17. The conversion kit of claim 11, wherein the rotor is a hollow generally cylindrical body, with an outer side wall incorporating the first and second magnets, an opposed interior side wall, and at least one open end, and wherein the interior side wall is complementarily shaped to the first end of the shaft.

18. The conversion kit of claim 17, wherein the cross sectional shape of the first end of the shaft is not circular.

19. The conversion kit of claim 18, wherein the cross sectional shape of the first end of the shaft is asymmetrical.

20. The conversion kit of claim 11, further comprising a first timing mark on the top side of the rotor and a second timing mark on the top of the at least one module, wherein the first and second timing marks are aligned to set the desired timing of the electrical output of the first module.
